(19) United States
(12) Patent Application Publication
(10) Pub. No.: US 2024/0296081 A1
(43) Pub. Date: Sep. 5, 2024

(54) METHOD, COMPUTER DEVICE AND STORAGE MEDIUM FOR PROTOCOL STACK DATA TRANSMISSION BASED ON LINUX SYSTEM

(71) Applicant: Beijing Bytedance Network Technology Co., Ltd., Beijing (CN)

(72) Inventor: Chengcheng Liu, Beijing (CN)

(21) Appl. No.: 18/573,781

(22) PCT Filed: Jul. 12, 2022
(86) PCT No.: PCT/CN2022/105026

§ 371 Date: Dec. 22, 2023

(30) Foreign Application Priority Data
Jul. 12, 2021 (CN) 202110785532.0
Oct. 9, 2021 (CN) 202111177649.7

(51) Int. Cl. G06F 9/54

(52) U.S. Cl. CPC G06F 9/542

(57) ABSTRACT

The disclosure provides a method, a computer device and a storage medium for protocol stack data transmission based on Linux® system. The method of the protocol stack data transmission based on Linux® system comprises: a kernel sending a first notification to an intermediate service module in response to the kernel detecting that a protocol stack sends first data to a driver chip controller; wherein the first notification is used to instruct the intermediate service module to receive the first data and forward the first data to the driver chip controller.

This application claims the benefit of the Chinese Patent Application No. 202110785532.0 filed to the Chinese Patent Office on Jul. 12, 2021, and the benefit of the Chinese Patent Application No. 202111177649.7 filed to the Chinese Patent Office on Oct. 9, 2021, which are hereby incorporated by reference in their entirety.

### FIELD

The present disclosure relates to the field of computers, for example, relates to a method, a computer device and a storage medium for protocol stack data transmission based on Linux® system.

### BACKGROUND

Protocol stack is a way of communication between an upper-layer application and underlying hardware. Protocol stack performs operations such as encapsulating, parsing, reading on data, and sends the data to a corresponding hardware driver, so that the corresponding hardware can perform its function. This requires the hardware manufacturer to provide source code or a driver for a specific scenario according to the protocol stack used by the system, while different systems often use different protocol stacks.

### SUMMARY

The present disclosure provides a method, a computer device and a storage medium for protocol stack data transmission based on Linux® system.

A method of protocol stack data transmission based on Linux® system is provided, and the method comprises:
a kernel sending a first notification to an intermediate service module in response to the kernel detecting that the protocol stack sends first data to a driver chip controller;
wherein the first notification is used to instruct the intermediate service module to receive the first data and forward the first data to the driver chip controller.

In one implementation, the intermediate service module receiving the first data and forwarding the first data to the driver chip controller comprises:
the intermediate service module calling a first interface function corresponding to the protocol stack to receive the first data;
the intermediate service module calling a second interface function corresponding to the driver chip controller to send the first data to the driver chip controller.

In one implementation, the kernel sending a first notification to an intermediate service module in response to the kernel detecting that the protocol stack sends first data to a driver chip controller comprises:
the protocol stack sending the first data to a Virtual Host Controller Interface (VHCI) node; the kernel sending the first notification to the intermediate service module in response to the kernel detecting that the VHCI node receives the first data.

In one implementation, the first interface function comprises g_io_channel_read_chars interface function, and the second interface function comprises gbinder_client_transact interface function.

In one implementation, the intermediate service module calling a second interface function corresponding to the driver chip controller to send the first data to the driver chip controller comprises:
the intermediate service module calling the second interface function to send the first data to a hwbinder node, causing the hwbinder node to send the first data to the driver chip controller through an HAL Interface Definition Language (HIDL) interface.

In one implementation, before the protocol stack sending data to the driver chip controller, the method further comprising: pre-registering the VHCI node and the hwbinder node in the kernel.

In one implementation, the method further comprises:
the driver chip controller sending second data to the protocol stack;
the kernel sending a second notification to the intermediate service module in response to the kernel detecting that the driver chip controller sends second data to the protocol stack;
wherein the second notification is used to instruct the intermediate service module to receive the second data and forward the second data to the protocol stack.

In one implementation, the intermediate service module receiving the second data and forwarding the second data to the protocol stack comprises:
the intermediate service module calling a third interface function corresponding to the driver chip controller to receive the second data;
the intermediate service module calling a fourth interface function corresponding to the protocol stack to send the second data to the protocol stack.

In one implementation, the kernel sending a second notification to the intermediate service module in response to the kernel detecting that the driver chip controller sends second data to the protocol stack comprises:
the chip controller sending the second data to the hwbinder node;
the kernel sending the second notification to the intermediate service module in response to the kernel detecting that the hwbinder node receives the second data.

In one implementation, the third interface function comprises gbinder_reader_read_hidl_vec interface function, and the fourth interface function comprises g_io_channel_write_chars interface function.

In one implementation, the intermediate service module calling a fourth interface function corresponding to the protocol stack to send the second data to the protocol stack comprises:
the intermediate service module calling the fourth interface function to send the second data to the VHCI node, causing the VHCI node to send the data to the protocol stack.

In one implementation, the protocol stake is BlueZ Bluetooth® protocol stack in Linux®; the driver chip controller is a Bluetooth® chip controller.

A computer device is further provided, and the computer device comprises: a memory and a processor, the memory stores a computer program, the processor is configured to, when executing the computer program, implement the aforementioned method of protocol stack data transmission based on Linux® system.

A computer-readable storage medium is further provided, and the computer-readable storage medium comprising one or more program instructions, the one or more program instructions configured to perform the aforementioned method of protocol stack data transmission based on Linux® system.

### BRIEF DESCRIPTION OF THE DRAWINGS

FIG. 1 is a flowchart of a method of protocol stack data transmission based on Linux® system according to embodiments of the present disclosure;

FIG. 2 is a schematic diagram of bidirectional data transmission of a protocol stack and a driver chip controller according to embodiments of the present disclosure; and

FIG. 3 is a schematic structural diagram of a computer device according to embodiment of the present disclosure.

### DETAILED DESCRIPTION

Technical solutions in the embodiments of the present disclosure will be described in the following in combination with the accompanying drawings. The described embodiments are only parts of the embodiments of the present disclosure.

The terms “first”, “second”, etc. in the present disclosure are used to distinguish similar objects and need not be used to describe a specific order or sequence. The data used in this way can be interchanged where appropriate in the embodiments of the present disclosure described herein. In addition, the terms “including” and “with” and any variations thereof are intended to cover non-exclusive inclusions, such as processes, methods, systems, products, or devices that include a series of steps or units, which need not be limited to those listed, but may include other steps or units that are not listed or inherent to these processes, methods, products, or devices.

The present disclosure will be described below with reference to the accompanying drawings and embodiments.

Host Controller Interface (HCI): it is an important part of the Bluetooth® protocol stack 202. HCI provides a unified interface for controllers to communicate between hosts and controllers. It is the interface between hardware and software in the Bluetooth® protocol. It provides a unified command for calling hardware such as lower-layer baseband (BB), Link Manager (LM), status and control registers. Message and data transmission between the upper and lower module interfaces must be interpreted by HCI. A protocol software entity above the HCI layer runs on the host, while the function below the HCI layer is implemented by a Bluetooth® device, and the two interact through a transport layer.

VHCI 204: Virtual Host Controller Interface, which is a virtual interface between a host and a controller.

Communications between the host and the controller are conducted in the form of packets. The data transmitted between the host and the controller is divided into three types: COMMAND packet, EVENT packet, and DATA packet. Herein the DATA packets are bidirectional, and COMMAND packet can only be sent from the host to the controller, while EVENT packet is always sent from the controller to the host. Most COMMAND packets sent by the host may trigger the controller to generate corresponding EVENT packets as a response.

For the Bluetooth® protocol stack 202, the Data packet may be divided into Data packet transmitted based on Asynchronous Connectionless (ACL) and Data packet transmitted based on Synchronous Connection Oriented (SCO).
Bluetooth® Hardware Abstract Layer (HAL): A Bluetooth® hardware adaptation layer.
Binder: Inter-Process Communication (IPC) between framework/application processes.
Hwbinder: IPC between framework/vendor processes 214.
HIDL 216: an interface between the Android® Framework and the Android® HAL implementation.
Controller: a controller.

For the Linux® system, its Bluetooth® protocol stack 202 BlueZ needs to adapt to the Bluetooth® driver for BlueZ provided by the Bluetooth® manufacturer, and register the HCI interface used by BlueZ, that is, the underlying driver relies more on the support of the manufacturer.

The present disclosure proposes a method of protocol stack data transmission based on Linux® system, and the method comprises:
a kernel sending a first notification to an intermediate service module in response to the kernel detecting that the protocol stack sends first data to a driver chip controller, to cause the intermediate service module to receive the first data and forward the first data to the driver chip controller.

By setting the intermediate service module which is interposed between the protocol stack and the driver chip controller, the interface function is called by the intermediate service module to transmit data, and IPC communication with the HIDL interface 216 is realized in the present disclosure. Using the method of the present disclosure, for different driver chip controllers, a normal bidirectional data transmission between the protocol stack in Linux® and the driver chip controller may still be realized, which improves the driver compatibility of the system for different Bluetooth® chips.

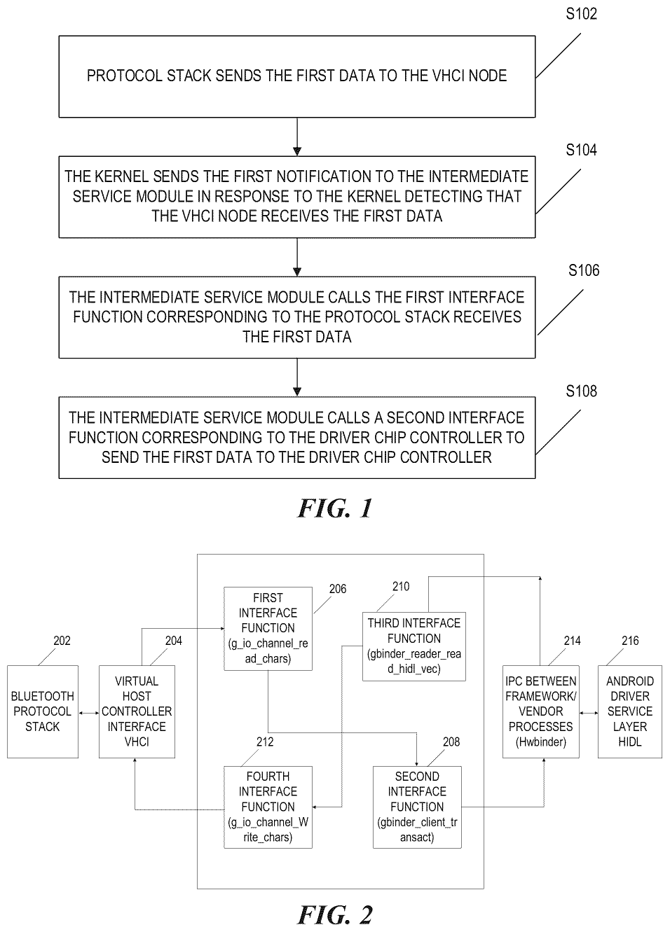

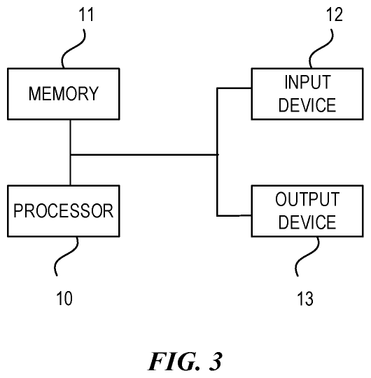

Referring to FIG. 1, the implementation process of the method of protocol stack data transmission based on Linux® system includes the following.
S102, the protocol stack sends the first data to the VHCI node 204.
S104, the kernel sends the first notification to the intermediate service module in response to the kernel detecting that the VHCI node 204 receives the first data.
S106, the intermediate service module calls the first interface function corresponding to the protocol stack receives the first data.
S108, the intermediate service module calls a second interface function corresponding to the driver chip controller to send the first data to the driver chip controller.

By setting the intermediate service module which is interposed between the protocol stack and the driver chip controller, the interface function is called by the intermediate service module to transmit data, and bidirectional transmission of data between the two is realized in the present disclosure. By adopting the method of the present disclosure, it will not cause difficulties in data exchange between the protocol stack and the driver chip controller due to the replacement of the driver chip controller, and it improves the driver compatibility of the system for different Bluetooth® chips, including a driver of Bluetooth® hardware that can be compatible with a BlueDroid protocol stack of Android®.

Referring to FIG. 2, an operation process of the intermediate service module of the present disclosure is shown.

First, the VHCI node 204 and the hwbinder node 214 are pre-registered in the kernel of the Linux® system.

When the protocol stack sends the first data to the driver chip controller, for example, the first data includes DATA packet, COMMAND packet, the kernel sends the first notification to the intermediate service module in response to the kernel detecting that the protocol stack sends the first data to the driver chip controller; the intermediate service module calls the first interface function 206 corresponding to the protocol stack to receive the first data, and calls a second interface function 208 corresponding to the driver chip controller to send the first data to the driver chip controller.

In one embodiment, the protocol stack sends the first data to the VHCI node 204; the kernel sends a notification message to the intermediate service module in response to the kernel detecting that the VHCI node 204 receives the first data; upon the intermediate service module receiving the notification message, the corresponding g_io_channel_read_chars interface function is called to receive the first data, and the gbinder_client_transact interface function is called to send the first data to the hwbinder node, so that the hwbinder node sends the first data to the HIDL interface 216 corresponding to the driver chip controller.

The HIDL interface 216 interacts HCI data with the driver chip controller through the HAL, thereby driving the underlying Bluetooth® chip controller.

In the above embodiments, the g_io_channel_read_chars and gbinder_client_transact are taken as examples to illustrate the first interface function 206 and the second interface function 208.

These are only illustrative, and other functions may also be employed, for example, the first interface function 206 and the second interface function 208 may be realized respectively using ioctl function with read and write parameters; or the first interface function 206 and the second interface function 208 may be realized respectively using standard socket interfaces write ( ) and read ( ).

Upon the driver chip controller receiving the COMMAND packet and the DATA packet, corresponding DATA packet and EVENT packet are generated. Correspondingly, the method of the present disclosure further includes the driver chip controller sending the second data to the protocol stack, and the kernel sending a second notification to the intermediate service module in response to the kernel detecting that the driver chip controller sends the second notification to the intermediate service module, causing the intermediate service module to receive the second data and forward the second data to the protocol stack.

Reference is continuously made to FIG. 2, the kernel sends the second notification to the intermediate service module in response to the kernel detecting that the driver chip controller sends the second data to the protocol stack, for example, the second data includes DATA packet and EVENT packet; the intermediate service module calls a third interface function 210 corresponding to the driver chip controller to receive the second data, and calls a fourth interface function 212 corresponding to the protocol stack to send the second data to the protocol stack.

In one embodiment, when the chip controller sends the second data to the protocol stack, the chip controller sends the second data to the hwbinder node, and the kernel sends the second notification to the intermediate service module in response to the kernel detecting that the hwbinder node receives the second data; upon the intermediate service module receiving the second notification, the intermediate service module calls the corresponding gbinder_reader_read_hidl_vec interface function to receive the second data; the g_io_channel_write_chars interface function is called to send the second data to the VHCI node 204, causing the VHCI node 204 to send the second data to the protocol stack, thereby completing interaction between the protocol stack in Linux® and Bluetooth® hardware.

The intermediate service module and the driver chip controller use the Android® standard interface service HIDL 216 to achieve an adaptation-free driver of the device. Compared with other manufacturers adapting to an HAL layer driver, the decoupling degree is higher, and the compatibility of interface versions is better.

The present disclosure also provides a computer device, including a processor 10, a memory 11, and an input device 12 and an output device 13 required to operate the computer device; the number of processors 10 in the computer device may be one or more, and the processor 10, the memory 11, the input device 12, and the output device 13 may be connected by a bus or other means.

The memory 11 as a computer-readable storage medium, may be configured to store a software program, a computer-executable program and a functional module, such as a program instruction/module corresponding to the embodiments of the present disclosure.

The memory 11 may include a high-speed random access memory and may also include a non-volatile memory, such as at least one disk storage device, flash memory device, or other non-volatile solid-state storage device. In some examples, the memory 11 may include a memory remotely arranged relative to the processor 10, which may be connected to the computer device through a network. Examples of the above network include but are not limited to the Internet, enterprise intranet, Local Area Network, a mobile communication network, and combinations thereof.

The input device 12 may be configured to receive input numeric or character information and generate a key signal input related to a user setting and a functional control of the computer device. The output device 13 may include a display device such as a display screen.

Embodiments of the present disclosure also provide a storage medium comprising computer-executable instructions, the computer-executable instructions configured to, when executed by a computer processor, implement the method mentioned above.

Through the above description of the embodiments, the present disclosure can be implemented by means of software and necessary general-purpose hardware, or by hardware. The technical solution of the present disclosure can essentially be embodied in the form of a software product, and the computer software product can be stored in a computer-readable storage medium, such as a floppy disk, a read-only memory (ROM), a random access memory (RAM), a flash memory (FLASH), a hard disk or an optical disk, etc., including multiple instructions for causing a computer device (which can be a personal computer, a server, or a network device, etc.) to implement the methods described in the embodiments of the present disclosure.

1. A method of protocol stack data transmission, comprising:
a kernel monitoring a protocol stack;
the kernel sending a first notification to an intermediate service module in response to the kernel detecting that the protocol stack sends first data to a driver chip controller, a intermediate service module being between the protocol stack and the driver chip controller,
wherein the first notification is used to call interface functions for instructing the intermediate service module to receive the first data and forward the first data to the driver chip controller.

2. The method of claim 1, wherein the first data is data sent by the protocol stack to a virtual host controller interface VHCI node,
the kernel sending a first notification to an intermediate service module in response to the kernel detecting that the protocol stack sends first data to a driver chip controller comprises:
the kernel sending the first notification to the intermediate service module in response to the kernel detecting that the VHCI node receives the first data.

3. The method of claim 1, wherein the intermediate service module receiving the first data and forwarding the first data to the driver chip controller comprises:
the intermediate service module calling a first interface function corresponding to the protocol stack to receive the first data; and
the intermediate service module calling a second interface function corresponding to the driver chip controller to send the first data to the driver chip controller.

4. The method of claim 3, wherein the intermediate service module calling a second interface function corresponding to the driver chip controller to send the first data to the driver chip controller comprises:
the intermediate service module calling the second interface function to send the first data to a hwbinder node, causing the hwbinder node to send the first data to the driver chip controller through an interface definition language HIDL interface.

5. The method of claim 1, further comprising:
the kernel sending a second notification to the intermediate service module in response to the kernel detecting that the driver chip controller sends second data to the protocol stack;
wherein the second notification is used to instruct the intermediate service module to receive the second data and forward the second data to the protocol stack.

6. The method of claim 5, wherein the second data is data sent by the chip controller to the hwbinder node, the kernel sending a second notification to the intermediate service module in response to the kernel detecting that the driver chip controller sends second data to the protocol stack comprises:
the kernel sending the second notification to the intermediate service module in response to the kernel detecting that the hwbinder node receives the second data.

7. The method of claim 5, wherein the intermediate service module receiving the second data and forwarding the second data to the protocol stack comprises:
the intermediate service module calling a third interface function corresponding to the driver chip controller to receive the second data; and
the intermediate service module calling a fourth interface function corresponding to the protocol stack to send the second data to the protocol stack.

8. The method of claim 5, wherein the intermediate service module calling a fourth interface function corresponding to the protocol stack to send the second data to the protocol stack comprises:
the intermediate service module calling the fourth interface function to send the second data to the VHCI node, causing the VHCI node to send the second data to the protocol stack.

9. A computer device, comprising: a memory and a processor, the memory storing a computer program, the processor configured to, when executing the computer program, implement acts comprising:
a kernel monitoring a protocol stack;
the kernel sending a first notification to an intermediate service module in response to the kernel detecting that the protocol stack sends first data to a driver chip controller, the intermediate service module being between the protocol stack and the driver chip controller,
wherein the first notification is used to call interface functions for instructing the intermediate service module to receive the first data and forward the first data to the driver chip controller.

10. A non-transitory computer-readable storage medium, comprising at least one program instruction, the at least one program instruction configured to perform acts comprising:
a kernel monitoring a protocol stack;
the kernel sending a first notification to an intermediate service module in response to the kernel detecting that the protocol stack sends first data to a driver chip controller, the intermediate service module being between the protocol stack and the driver chip controller,
wherein the first notification is used to call interface functions for instructing the intermediate service module to receive the first data and forward the first data to the driver chip controller.

11. The computer device of claim 9, wherein the intermediate service module receiving the first data and forwarding the first data to the driver chip controller comprises:
the intermediate service module calling a first interface function corresponding to the protocol stack to receive the first data; and
the intermediate service module calling a second interface function corresponding to the driver chip controller to send the first data to the driver chip controller.

12. The computer device of claim 11, wherein the intermediate service module calling a second interface function corresponding to the driver chip controller to send the first data to the driver chip controller comprises:
the intermediate service module calling the second interface function to send the first data to a hwbinder node, causing the hwbinder node to send the first data to the driver chip controller through an HAL Interface Definition Language HIDL interface.

13. The computer device of claim 9, further comprising:
the kernel sending a second notification to the intermediate service module in response to the kernel detecting that the driver chip controller sends second data to the protocol stack;
wherein the second notification is used to instruct the intermediate service module to receive the second data and forward the second data to the protocol stack.

14. The computer device of claim 13, wherein the second data is data sent by the chip controller to the hwbinder node, the kernel sending a second notification to the intermediate service module in response to the kernel detecting that the driver chip controller sends second data to the protocol stack comprises:
the kernel sending the second notification to the intermediate service module in response to the kernel detecting that the hwbinder node receives the second data.

15. The computer device of claim 13, wherein the intermediate service module receiving the second data and forwarding the second data to the protocol stack comprises:
the intermediate service module calling a third interface function corresponding to the driver chip controller to receive the second data; and
the intermediate service module calling a fourth interface function corresponding to the protocol stack to send the second data to the protocol stack.

16. The computer device of claim 13, wherein the intermediate service module calling a fourth interface function corresponding to the protocol stack to send the second data to the protocol stack comprises:
the intermediate service module calling the fourth interface function to send the second data to the VHCI node, causing the VHCI node to send the second data to the protocol stack.

17. The computer device of claim 9, wherein the first data is data sent by the protocol stack to a Virtual Host Controller Interface VHCI node, the kernel sending a first notification to an intermediate service module in response to the kernel detecting that the protocol stack sends first data to a driver chip controller comprises:
the kernel sending the first notification to the intermediate service module in response to the kernel detecting that the VHCI node receives the first data.

18. The non-transitory computer-readable storage medium of claim 10, wherein the first data is data sent by the protocol stack to a Virtual Host Controller Interface VHCI node, the kernel sending a first notification to an intermediate service module in response to the kernel detecting that the protocol stack sends first data to a driver chip controller comprises:
the kernel sending the first notification to the intermediate service module in response to the kernel detecting that the VHCI node receives the first data.

19. The non-transitory computer-readable storage medium of claim 10, wherein the intermediate service module receiving the first data and forwarding the first data to the driver chip controller comprises:
the intermediate service module calling a first interface function corresponding to the protocol stack to receive the first data; and
the intermediate service module calling a second interface function corresponding to the driver chip controller to send the first data to the driver chip controller.

20. The non-transitory computer-readable storage medium of claim 19, wherein the intermediate service module calling a second interface function corresponding to the driver chip controller to send the first data to the driver chip controller comprises:
the intermediate service module calling the second interface function to send the first data to a hwbinder node, causing the hwbinder node to send the first data to the driver chip controller through an HAL Interface Definition Language HIDL interface.
